(19) United States
(12) Patent Application Publication
(10) Pub. No.: US 2025/0110013 A1
(43) Pub. Date: Apr. 3, 2025

(54) METHODS AND SYSTEMS FOR MONITORING PIPELINE WITH FIBER OPTIC CABLE

(71) Applicant: MARATHON PETROLEUM COMPANY LP, Findlay, OH (US)

(72) Inventors: Jason S. Dalton, Findlay, OH (US); Stephen Daniel Ernst, Findlay, OH (US)

(21) Appl. No.: 18/898,551

(22) Filed: Sep. 26, 2024

Related U.S. Application Data
(60) Provisional application No. 63/541,159, filed on Sep. 28, 2023.

(51) Int. Cl. G01M 3/28

(52) U.S. Cl. CPC G01M 3/2815

(57) ABSTRACT

Methods and systems to monitor a pipeline for a leak or rupture. An embodiment of the system may include sensor assemblies. Each of the sensor assemblies may include an optical signal generator, an input, an output, and a transmission time circuitry configured to determine a transmission time of the optical signal. The transmission time circuitry may be configured to generate a transmission time data packet including the transmission time. Each of the sensor assemblies may include a fiber optic cable positionable about a circumference of the pipeline and connected to the output and the input. The system may include a controller connected to each of the sensor assemblies and configured to prompt each of the plurality of sensor assembly to generate the optical signal and determine whether the leak or the rupture has occurred based on the transmission time data packet from each of the plurality of sensor assemblies.

### CROSS REFERENCE TO RELATED APPLICATIONS

This application claims priority to and the benefit of U.S. Provisional Application No. 63/541,159, filed Sep. 28, 2023, titled “METHODS AND SYSTEMS FOR MONITORING PIPELINE WITH FIBER OPTIC CABLE,” the disclosure of which is incorporated herein by reference in its entirety.

### FIELD OF DISCLOSURE

Embodiments herein generally relate to the use of fiber optic cable to monitor a pipeline. More specifically, one or more embodiments relate to fiber optic or sensor assemblies and methods and systems for utilizing the fiber optic or sensor assemblies to monitor pipeline for leaks, ruptures, and/or one or more other pipeline events.

### BACKGROUND

Pipeline is positioned throughout various environments worldwide to transport various fluids, such as hydrocarbons and/or renewable hydrocarbons, as well as water and/or other fluids, each in a liquid or gaseous state. For example, hundreds of thousands of miles of pipeline are positioned throughout the United States alone. To ensure that the pipeline remains environmentally sound, each pipeline is monitored in a variety of ways.

Typically, pipelines have been monitored for leaks or ruptures using a variety of techniques. Visual inspection is the most utilized technique, but visual inspection requires time and personnel, as well as other resources (such as cameras and vehicles, among other equipment). Pressure sensors have also been utilized to monitor pipeline. However, to utilize pressure sensors, the pressure sensors must make contact with the fluid inside the pipeline. Thus, to install or mount such pressure sensors, a hole is drilled into the pipeline, the pressure sensor inserted therein, and then the hole is sealed. The drilling of such holes introduce potential failure points and maintenance of such pressure sensors are costly and time consuming, as a technician has to remove the seal, replace the pressure sensor, and reseal the hole. Further, since the pressure sensor is within the pipeline, the pressure sensor is exposed to a variety of fluids and may, in some instances, be an obstacle or cause a blockage.

Alternatively, fiber Bragg grating sensors have been used, to a degree, in determining pipeline circumference and/or pipeline strain. However, fiber Bragg grating sensors are very sensitive to temperature and, since these pipelines are typically exposed to the environment, would not be suitable to determine whether a leak has occurred. Further still, such fiber Bragg grating sensors have not been utilized on actual pipeline and may not function as desired due to the sensitivities experienced by the fiber Bragg grating sensors.

Finally, fiber optical cable has been utilized to determine pipeline leaks, however, such uses rely on a continuous length of fiber optical cable run down the length of a pipeline, not positioned about the circumference of a pipeline. As the pipeline experiences a rupture, an apparatus attached on one side to the pipeline and on another side to the fiber cable, pushes (based on the strain produced within the pipeline) against the fiber, causing a change in the time an optical signal is received. However, the use of such a fiber optical cable also create a variety of issues. First, the length of a cable needed for a pipeline running from one location to another would be substantial, thus creating a large cost. Second, exposure to the environment could cause damage to the fiber optic cable at many different points, particularly since such a large length of fiber optic cable is used.

### SUMMARY

In view of the foregoing, Applicant has recognized these problems and others in the art, and has recognized a need for enhanced systems and methods for use of fiber optic cable to monitor a pipeline and, particularly, fiber optic or sensor assemblies and methods and systems for utilizing the fiber optic or sensor assemblies to monitor pipeline for leaks, ruptures, and/or one or more other pipeline events.

The disclosure herein provides embodiments of systems and methods for monitoring pipeline using fiber optic cable. In particular, one or more embodiments relate to fiber optic assemblies and methods and systems for utilizing the fiber optic assemblies to monitor pipeline for leaks, ruptures, and/or one or more other pipeline events. In such embodiments, the fiber optic assembly (also referred to as a sensor assembly) may include a transceiver or, in another embodiment, an optical signal receiver and an optical signal transmitter. Further, the sensor assembly may include an optical signal generator, communications circuitry, and/or a length of fiber optic cable. A first end of the fiber optic cable may be connected to a first end of the transceiver or the optical signal transmitter. A second end of the fiber optic cable may be connected to a second end of the transceiver or the optical signal receiver. Further, the fiber optic cable may be wrapped or positioned around a selected area or portion of the pipeline. The fiber optic cable may be wrapped or looped around the selected area of the pipeline one or more times. The number of loops may be dependent on the other components included in the fiber optic assemblies. For example, circuitry included in the fiber optic assembly to determine a time-of-flight or transmission time may take a selected amount of time to determine the time-of-flight or transmission. Based on such a selected amount of time, the number of loops may be increased or decreased. For example, the number of loops of fiber cable utilized may be decreased as the speed of determination of flight-of-time or transmission time increases. The sensor assemblies may also include a power supply. The power supply may include one or more of a battery, a capacitor, a solar panel, or circuitry configured to connect to an external power source (for example, a power source located proximate or within a pumping station, source, and/or destination).

A plurality of the sensor assemblies may be positioned at varying lengths along the pipeline. For example, each of the plurality of sensor assemblies may be spaced about 1 mile, about 2 miles, about 5 miles, about 15 miles, or even greater than 15 miles apart. In other embodiments, each of the sensor assemblies may be in closer proximity to one another. In yet another embodiment, the spacing of sensor assemblies may be dependent upon the longest span of pipeline that is not interrupted. In another embodiment, in the event of a leak or rupture, the wave speed of fluid within the pipeline may be about 0.5 to about 0.75 miles per second. In such an embodiment, the spacing of sensor assemblies may not be less than lower range of the wave speed of fluid. Each of the sensor assemblies may be communicatively connected to, at least, one of the other sensor assemblies (such as adjacent assemblies). In another embodiment, the system may include a controller or computing device. The controller or computing device may connect to a relay or communication subsystem or network (for example, a cellular network or satellite based network). Each of the plurality of sensor assemblies may connect to the relay or communication subsystem or network. In an embodiment, the controller may send a signal to each of the plurality of sensor assemblies indicating to each of the plurality of sensor assemblies to generate an optical signal. The optical signal may travel through the fiber optic cable from the transmitter to the receiver. Each sensor assembly may determine the time-of-flight or transmission time of the optical signal. The sensor assembly may then generate a packet, including the transmission time, the reception time, the time-of-flight or transmission time, a time stamp, and location data. As the controller (or, as noted, the computing device) receives each packet form each sensor assembly, the controller may read or parse each packet. The controller may utilize historical data, as well as current data, to determine whether an event has occurred. Further, as wear and/or other changes to the pipeline occur over time, the controller may ensure that variations caused by such wear and/or other changes are logged, sent to a user, and/or marked as such. While it may be desirable to resolve or perform remedial action regarding the wear and/or other changes, such actions may not be urgent and may be performed at a later time. If, however, the data indicates that an event has occurred, then the controller may generate an alert including the type of event and the approximate location of the event.

In an embodiment, the event may include a leak or a rupture. In other embodiments, the data may be utilized to determine occurrence of other events or measure and adjust other characteristics of the pipeline. For example, the controller may determine and/or track the location of a pig in the pipeline, determine the wave speed of fluid within the pipeline, determine wall thickness of various locations of the pipeline (over time and/or upon initialization of the system), determine whether a blockage exists within the pipeline at a particular location, whether a water hold-up exists within the pipeline at a particular section, batch interface tracking, determine ground temperature, and/or determine characteristics of the fluid within the pipeline.

In an embodiment, each of the sensor assemblies may be attached to the pipeline via an adhesive or mechanical fasteners. In an embodiment, the sensor assembly may be welded to the pipeline. In yet another embodiment, the sensor assembly may be configured to easily and quickly attach to the pipeline, such that any user may position the sensor assembly to the pipeline.

In another embodiment, the sensor assembly may be configured to generate an alert if the sensor assembly experiences a power failure and/or or becomes compromised or damaged (for example, as determined by lack of reception of an optical signal). Such an alert may include the location of the sensor assembly and the issue causing the alert.

Thus, since the sensor assemblies may be spaced at great distances apart, fewer resources are needed, while leaks, ruptures and/or other events may be detected and locations of such events may be determined. Further, the sensor assemblies are a non-intrusive and accurate pipeline monitoring solution, while offering higher reliability and serviceability than other typical pipeline monitoring solutions.

Accordingly, an embodiment of the disclosure is directed to a system to monitor a pipeline for a leak or rupture. The system may include a plurality of sensor assemblies. Each of the sensor assemblies may include a transceiver. The transceiver may include an optical signal generator to, in response to a prompt, generate an optical signal; an input; an output; and a transmission time circuitry. The transmission time circuitry may be configured to determine a transmission time of the optical signal based on a period of time between transmission via the output and reception via the input of the optical signal. The transmission time may indicate a change in circumference of the pipeline at a location of one of the plurality of sensor assemblies based on previous transmission times. The transmission time circuitry may be configured to generate a transmission time data packet including the transmission time, a timestamp, and the location of the transceiver. Each of the sensor assemblies may include a fiber optic cable positionable about a circumference of the pipeline. The fiber optic cable may include a first end connected to the output of the transceiver and to receive the optical signal from the optical signal generator and a second end connected to the input of the transceiver and to receive the optical signal via the first end and provide the optical signal to the input. Each of the sensor assemblies may include a communications circuitry configured to transmit the transmission time data packet. The system may include a controller connected to the communications circuitry of each of the plurality of sensor assemblies. The controller may be configured to prompt each of the plurality of sensor assembly to substantially simultaneously generate the optical signal, receive the transmission time data packet from each the plurality of sensor assembly, and determine whether one of the leak or the rupture has occurred based on the transmission time data packet from each of the plurality of sensor assembly.

In an embodiment, determination of occurrence of one of the leak or the rupture is indicated based on (a) a first transmission time data packet from a first sensor assembly including first timestamp and a different transmission time than previously received transmission times and (b) a second transmission time data packet from a second sensor assembly including a second timestamp and another different transmission time than previously received transmission times, the second timestamp comprising a time subsequent to the first timestamp.

In an embodiment, the controller may be configured to determine a location of the one of the leak or rupture based on a plurality of transmission time data packets received from two or more of the plurality of sensor assemblies over a selected time period. The controller may also be configured to generate an alert comprising the location of the one of the leak or rupture and a time that the leak or rupture has occurred in response to a determination that one of a leak or rupture has occurred.

In an embodiment, the system may include a power source. The power source may comprise one or more of an energy storage device or a solar power cell.

In an embodiment, the controller may be configured to generate an alert indicating sensor assembly location and sensor assembly maintenance, in response to a lack of reception of transmission time data packets from any one of the plurality of sensor assemblies.

In another embodiment, the controller may be configured to determine a transmission time profile for each one of the plurality of sensor assemblies based on a plurality of transmission time data packets for each corresponding one of the plurality of sensor assemblies.

In an embodiment, the controller may be configured to determine whether the one of the leak or rupture has occurred based on transmission time profiles and currently received transmission time data packets.

In another embodiment, the controller may be configured to determine whether, in addition to the one of the leak or rupture, an event has occurred. The event may comprise a blockage, passage of a pig through the pipeline, a water hold-up, or other event.

In another embodiment, each of the plurality of sensor assemblies are positioned about the circumference of the pipeline at one of about 1 mile, about 5 miles, about 10 miles, about 15 miles apart, about 100 miles, or even further apart. Stated another way, the sensor assemblies may be within about 1 mile, about 5 miles, about 10 miles, about 15 miles apart, about 100 miles, or an even further distance of adjacent sensor assemblies.

In another embodiment, the prompt to generate the optical signal may be transmitted to each of the plurality of sensor assemblies at a selected time interval.

Another embodiment of the disclosure is directed to a fiber optic sensor assembly to monitor a pipeline for a plurality of events. The fiber optic sensor assembly may include an optical signal generator to generate an optical signal in response to a prompt. The fiber optic sensor assembly may include an optical signal receiver. The fiber optic sensor assembly may include an optical signal transmitter. The fiber optic sensor assembly may include a transmission time circuitry. The transmission time circuitry may be configured to determine a transmission time of the optical signal based on a period of time between transmission via the optical signal transmitter and reception via the optical signal receiver of the optical signal, the transmission time to indicate (a) a change in circumference of the pipeline at a location of the fiber optic sensor assembly based on previous transmission times and (b) occurrence of one of the plurality of events based on the previous transmission times and transmission times from adjacent fiber optic sensor assemblies. The transmission time circuitry may be configured to generate a transmission time data packet including the transmission time, a timestamp, and the location of the fiber optic sensor assembly. The fiber optic sensor assembly may include a fiber optic cable positionable about a circumference of the pipeline. The fiber optic cable may include a first end connected to the optical signal transmitter and to receive the optical signal from the optical signal generator and a second end connected to the optical signal receiver and to receive the optical signal via the first end and provide the optical signal to the optical signal receiver. The fiber optic sensor assembly may include a communications circuitry configured to transmit the transmission time data packet.

In an embodiment, the communications circuitry may be configured to connect to one or more of a controller or the adjacent fiber optic sensor assemblies.

The fiber optic sensor assembly may include a fiber optic housing, and wherein the optical signal generator, the optical signal receiver, the optical signal transmitter, the transmission time circuitry, and the communications circuitry may be positioned substantially within the fiber optic housing. A lower surface of the fiber optic housing may include a connector. The connector may include one or more of a mechanical fastener or adhesive to attach the fiber optic housing to the pipeline.

Another embodiment of the disclosure is directed to a kit to provide a plurality of sensor assemblies to monitor a pipeline for selected events. The kit may include a container. The kit may include a plurality of sensor assemblies positioned within the container. Each of the sensor assemblies may include an optical signal generator to, in response to a prompt, generate an optical signal, an optical signal receiver, an optical signal transmitter, and a transmission time circuitry. The transmission time circuitry may be configured to determine a transmission time of the optical signal based on a period of time between transmission via the optical signal transmitter and reception via the optical signal receiver of the optical signal. The transmission time may indicate (a) a change in circumference of the pipeline at a location of one of the plurality of sensor assemblies based on previous transmission times and (b) occurrence of one of the selected events based on previous transmission times and transmission times from adjacent sensor assemblies. The transmission time circuitry may be configured to generate a transmission time data packet including the transmission time, a timestamp, and the location of the one of the plurality of sensor assemblies. Each of the sensor assemblies may also include a fiber optic cable positionable about a circumference of the pipeline. The fiber optic cable may include a first end configured to connect to the optical signal transmitter and to receive the optical signal from the optical signal generator and a second end configured to connect to the optical signal receiver and to receive the optical signal via the first end and provide the optical signal to the optical signal receiver. Each of the sensor assemblies may also include a communications circuitry configured to transmit the transmission time data packet and a fiber optic housing to substantially contain the optical signal generator, the optical signal receiver, the optical signal transmitter, the transmission time circuitry, and the communications circuitry within. The kit may include a plurality of connectors to connect each fiber optic housing and fiber optic cable about the circumference of the pipeline.

In another embodiment, each of the plurality of sensor assemblies may include a power source configured to connect to the optical signal generator and the communications circuitry. The power source may be positioned substantially within the fiber optic housing.

In another embodiment each of the plurality of sensor assemblies may include at least two redundant power sources each configured to connect to the optical signal generator and the communications circuitry. The redundant power sources may be positioned substantially within the fiber optic housing and may be hot-swappable.

Another embodiment of the disclosure is directed to a method to monitor a pipeline for selected events. The method may include generating a prompt to indicate generation of an optical signal at each of a plurality of sensor assemblies and determination of a transmission time that corresponds to transmission of the optical signal through a fiber optic cable associated with one of the plurality of sensor assemblies, the fiber optic cable positioned about the circumference of the pipeline. The method may include transmitting the optical signal at each of the plurality of sensor assemblies from an optical transmitter associated with one of the plurality of sensor assemblies. The method may include receiving the optical signal at optical input associated with the one of the plurality of sensor assemblies. The method may include determining a transmission time of the optical signal. The method may include generating a transmission time data packet to include, the transmission time, location of the one of the plurality of sensor assemblies, and a timestamp to indicate when the optical signal was generated. The method may include determining if one of the selected events has occurred based on transmission time data packets from the plurality of sensor assemblies and previously generated transmission time data packets from the plurality of sensor assemblies. In an embodiment, the selected events include one or more of a leak or rupture.

Another embodiment of the disclosure is directed to a method to a method to monitor a pipeline for selected events. The method may include transmitting an optical signal at one or more of a plurality of sensor assemblies from an optical transmitter associated with one of the plurality of sensor assemblies. The method may include receiving the optical signal at optical input associated with the one of the plurality of sensor assemblies. The method may include determining a transmission time of the optical signal. The method may include generating a transmission time data packet to include, the transmission time, location of the one of the plurality of sensor assemblies, and a timestamp to indicate when the optical signal was generated. The method may include determining if one of the selected events has occurred at a location of the pipeline based on transmission time data packets from the plurality of sensor assemblies and previously generated transmission time data packets from the plurality of sensor assemblies. In an embodiment, the method may include determining one or more characteristics of the pipeline based on the transmission time data packets from the plurality of sensor assemblies and previously generated transmission time data packets from the plurality of sensor assemblies. In yet another embodiment, the method may include correlating the transmission time of the optical signal to a differential pressure, and wherein determination if the one of the selected events has occurred is based on the differential pressure.

Still other aspects and advantages of these embodiments and other embodiments, are discussed in detail herein. Moreover, it is to be understood that both the foregoing information and the following detailed description provide merely illustrative examples of various aspects and embodiments, and are intended to provide an overview or framework for understanding the nature and character of the claimed aspects and embodiments. Accordingly, these and other objects, along with advantages and features of the present disclosure herein disclosed, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

These and other features, aspects, and advantages of the disclosure will become better understood with regard to the following descriptions, claims, and accompanying drawings. It is to be noted, however, that the drawings illustrate only several embodiments of the disclosure and, therefore, are not to be considered limiting of the scope of the disclosure.

FIG. 1A, FIG. 1B, FIG. 1C, and FIG. 1D are schematic diagrams of a plurality of sensor assemblies connected to a pipeline to monitor the pipeline for one or more events, according to an embodiment of the disclosure.

FIG. 1E and FIG. 1F are schematic diagrams of a fiber optic cable and the path a signal may travel therethrough based on a bend or change in the fiber optic cable, according to an embodiment of the disclosure.

FIG. 1G is a simplified diagram illustrating one of the sensor assemblies, according to an embodiment of the disclosure.

FIG. 2A, FIG. 2B, and FIG. 2C are schematic diagrams illustrating examples of the plurality of sensor assemblies for detecting an event, according to an embodiment of the disclosure.

FIG. 3 is another simplified diagram illustrating a control system for managing each of the sensor assemblies, according to an embodiment of the disclosure.

FIG. 4 is a schematic diagram of a kit containing the sensor assemblies, fiber optic cable, adhesive, and/or fasteners, according to an embodiment of the disclosure.

FIG. 5 is a flow diagram for monitoring a pipeline for a leak or rupture, according to an embodiment of the disclosure.

### DETAILED DESCRIPTION

So that the manner in which the features and advantages of the embodiments of the systems and methods disclosed herein, as well as others that will become apparent, may be understood in more detail, a more particular description of embodiments of systems and methods briefly summarized above may be had by reference to the following detailed description of embodiments thereof, in which one or more are further illustrated in the appended drawings, which form a part of this specification. It is to be noted, however, that the drawings illustrate only various embodiments of the systems and methods disclosed herein and are therefore not to be considered limiting of the scope of the systems and methods disclosed herein as it may include other effective embodiments as well.

The present disclosure generally relates to systems and methods for monitoring pipeline using fiber optic cable. In particular, one or more embodiments relate to fiber optic or sensor assemblies (referred to as a sensor assembly) and methods and systems for utilizing a plurality of sensor assemblies to monitor pipeline for leaks, ruptures, and/or one or more other pipeline events. In such embodiments, each of the plurality of sensor assemblies may include an optical signal receiver and an optical signal transmitter. The optical signal receiver and the optical signal transmitter may be included in or as a transceiver. Further, the sensor assembly may include an optical signal generator (which may be included in or separate from the transceiver), communications circuitry, and/or a length of fiber optic cable.

The fiber optic cable may include a first end and a second end. The first end of the fiber optic cable may be connected to the optical signal transmitter or an output (associated with the optical signal transmitter) of the transceiver. The second end of the fiber optic cable may be connected to the optical signal receiver or the input (associated with the optical signal receiver) of the transceiver. For each sensor assembly, the fiber optic cable may be wrapped or positioned around a selected area or portion of the pipeline. The fiber optic cable may be wrapped or looped around the selected area of the pipeline one or more times.

Each of the plurality of sensor assemblies may also include a power supply. The power supply may include one or more of a battery, a capacitor, a solar panel, or power circuitry configured to connect to an external power source (for example, a power source located proximate or within a pumping station, source, and/or destination).

Each of plurality of the sensor assemblies may be positioned at a varying length from adjacent sensor assemblies along the pipeline. For example, each of the plurality of sensor assemblies may be spaced about 1 mile, about 2 miles, about 5 miles, about 15 miles, about 25 miles, or even greater than 25 miles apart. In other embodiments, each of the sensor assemblies may be in closer proximity to one another. Each of the sensor assemblies may be communicatively connected to, at least, one of the other sensor assemblies (such as adjacent sensor assemblies). In another embodiment, such systems and methods may include or utilize a controller or computing device. The controller or computing device may connect to a relay, communication circuitry, or network (for example, a cellular network or satellite based network). Each of the plurality of sensor assemblies may connect to the relay, communication circuitry, or network. In an embodiment, the controller may send a signal to each of the plurality of sensor assemblies, the signal indicating to each of the plurality of sensor assemblies to generate an optical signal. In another embodiment, the controller may program each of the plurality of sensor assemblies to generate the optical signal at a predetermined, preselected, or selected time (in other embodiments, each of the plurality of sensor assemblies may be pre-programmed to automatically generate an optical signal at selected intervals). In an embodiment, the time between each generated optical signal may be about 30 seconds, about 1 minute, about 30 minutes, or about 1 hour. In a further embodiment, the controller may adjust such a time based on previous determinations of pipeline events. For example, if no leak or rupture has occurred in a selected amount of time, the controller may cause the sensor assemblies to generate optical signals at a lower frequency.

The optical signal generator may generate the optical signal at the selected time. The optical signal may travel from the optical signal generator to the optical signal transmitter through the fiber optic cable to the optical signal receiver. Since each of the plurality of sensor assemblies utilize an optical signal (for example, a laser or other light source), the speed at which the optical signal travels through the fiber optic cable is near the speed of light in a vacuum divided by the refractive index of the material within the fiber optic cable. Thus, while time intervals over 1 second may be utilized, time intervals less than 1 second or 0.1 seconds may be utilized. In other words, optical signals may be generated more than once per second.

Each of the plurality of sensor assemblies, via a transmission time circuitry, may determine the time-of-flight or transmission time of the optical signal (in other words, the time taken for the optical signal to travel from the optical signal transmitter to the optical signal receiver). The transmission time may indicate a change in circumference (or, in some embodiments, expansion or contraction) of the pipeline at a location of one of the plurality of sensor assemblies based on one or more previous transmission times. Further, pressure changes within the pipeline may change the transmission time (for example, via the expansion or contraction of the pipeline based on those pressure changes). Further still, the transmission time may change based on the number of times a fiber optic cable loops around the circumference of the pipeline, material properties of the pipeline, a wall thickness of the pipeline, and/or a magnitude of pressure change that results from one of the leak or the rupture. After determining the time-of-flight or transmission time, the sensor assembly may generate a packet. The packet may include the optical signal transmission time, the optical signal reception time, the time-of-flight or transmission time, a time stamp, and/or location data. In another embodiment, the packet may include a plurality of transmission times, along with a corresponding time stamp indicating when optical signal transmission was initiated. As the controller (or, as noted, the computing device) receives each packet from each sensor assembly, the controller may read or parse each packet. The controller may determine, based on the data included in each packet from various times or intervals, whether an event has occurred (such as a leak, rupture, and/or other pipeline event).

In addition to utilizing the data received from each packet, the controller may utilize historical data from each sensor assembly to determine whether an event has occurred. Prior to such a determination, the controller may receive packets including data indicating normal or typical pipeline conditions. Thus, if the time-of-flight or transmission time changes, then the controller may determine whether an event has occurred. Further, the controller may determine, based on historical data, what selected changes in time-of-flight or transmission time mean, in relation to type of event. In other words, different events may cause different changes in time-of-flight or transmission time, and based on those differences, the controller may determine and/or classify selected changes as being related to specific events (for example, a leak, a rupture, passage of a pig through the pipeline, and/or occurrence of a blockage, among other events).

In another example, as wear and/or other changes to the pipeline occur over time, the controller may ensure that variations in time-of-flight caused by such wear and/or other changes are logged, sent to a user, and/or marked as such. While it may be desirable to resolve or perform remedial action regarding the wear and/or other changes, such action may not be urgent. If, however, the data indicates that an event has occurred, then the controller may generate an alert including the type of event and the approximate location of the event.

In such embodiments, the controller may include or generate one or more models or profiles. The models or profiles may be generated using historical and/or experimental data. For example, data may be generated while an event occurs. Such an event may be manually initiated. Further, the pipeline generating the data may be positioned in a laboratory or testing facility, enabling multiple events to be manually initiated. Using this data (and, in another embodiment, similar data analyzed by a user and marked to indicate particular events), the controller or other computing device may generate models or profiles that are utilized to determine the type of event occurring based on various changes in transmission times for one or more sensor assemblies. Further, the models may also be used to determine various measurements or properties of the pipeline or fluid therein. In another example, the controller may record data during normal pipeline operation, such as differential pressure. When an event occurs or any change to the fluid within the pipeline, the controller may utilize the previously recorded data to determine a type of event. In yet another example, the controller may utilize normal differential pressure data (for example, a difference between the pressure recorded from one sensor assembly to the next) to determine the bulk modulus of the fluid being transported within the pipeline. Such data (for example, differential pressure and/or the bulk modulus) may be utilized to tune existing leak detection models, algorithms, and/or systems, thus increasing accuracy (for example, differentiating between a false positive and a true positive) and increasing sensitivity (for example, detecting events at lowest detectable levels, such as a pinhole leak).

In an embodiment, the event may include a leak, a pinhole leak, or a rupture. In other embodiments, the data may be utilized to determine occurrence of other events or measure and adjust other characteristics of the pipeline. For example, the controller may determine and/or track the location and/or status of a pig in the pipeline, determine the wave speed of fluid within the pipeline, determine wall thickness of various locations of the pipeline (over time and/or upon initialization of the system), determine whether a blockage exists within the pipeline at a particular location, determine whether a water hold-up exists within the pipeline at a particular section, batch interface tracking, determine ground temperature, and/or determine characteristics of the fluid within the pipeline.

In an embodiment, each of the sensor assemblies may be attached to the pipeline via an adhesive and/or mechanical fasteners. In an embodiment, the sensor assembly may be welded to the pipeline. In yet another embodiment, the sensor assembly may be configured to easily and quickly attach to the pipeline, such that any user or technician may attach the sensor assembly to the pipeline with a minimal amount or no tools.

In another embodiment, the sensor assembly may be configured to generate an alert if the sensor assembly experiences a power failure and/or or becomes compromised or damaged, such as, for example, if the controller fails to receive a data packet after prompting a sensor assembly to generate an optical signal. Such an alert may include the location of the sensor assembly and the issue causing the alert.

Thus, since the sensor assemblies may be spaced at, in some embodiments, great distances apart, fewer resources are needed, while leaks, ruptures and/or other events may be detected and locations of such events may be determined. Further, the sensor assemblies are a non-intrusive and accurate pipeline monitoring solution, offering higher reliability and serviceability than other typical pipeline monitoring solutions.

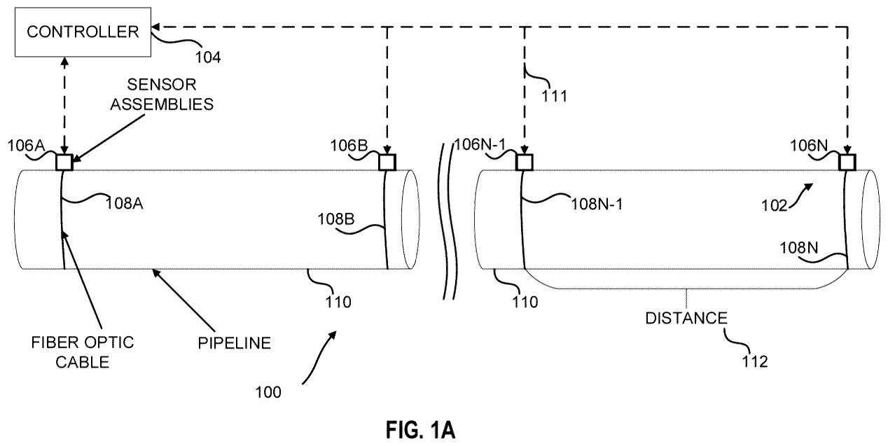

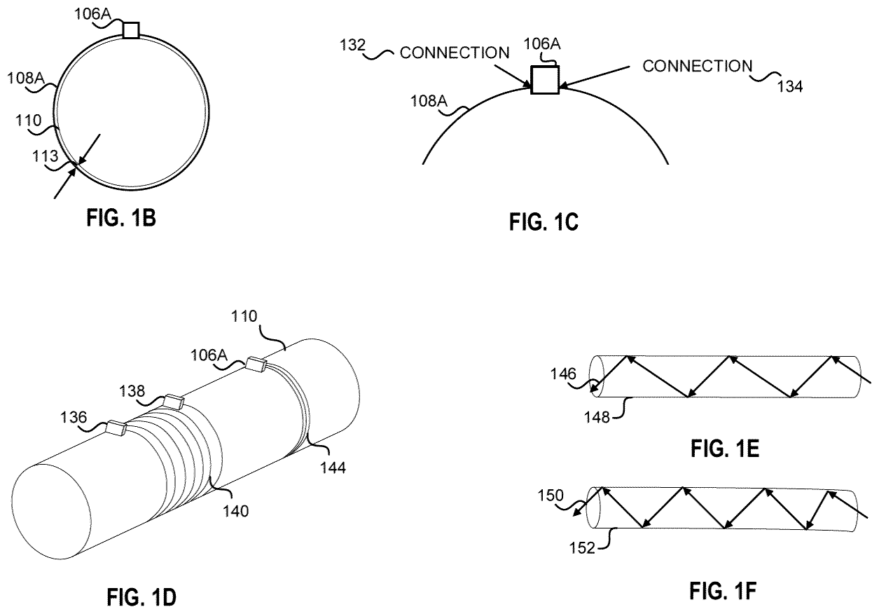

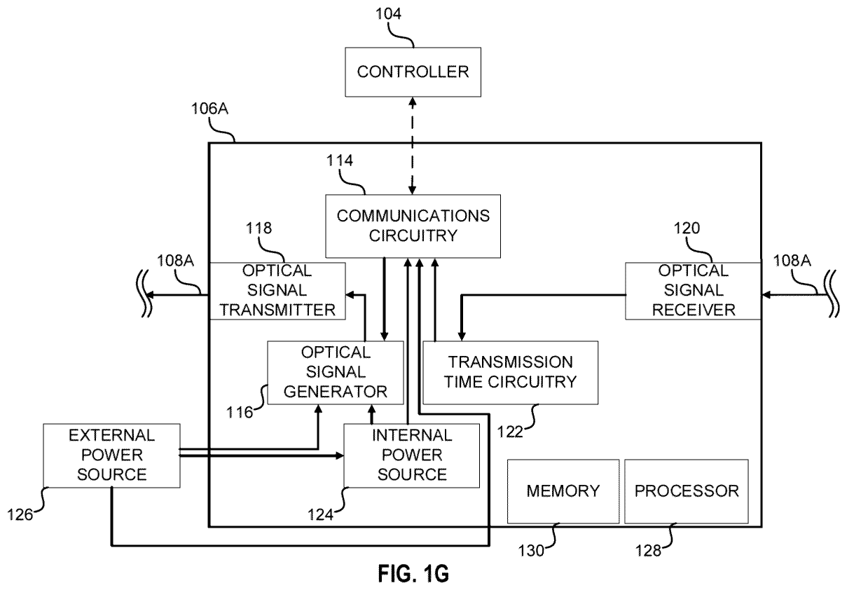

FIG. 1A and FIG. 1B are schematic diagrams of a system 100 including a plurality of sensor assemblies 106A, 106B, 106N−1, and up to 106N attached or connected to a pipeline 110 to monitor the pipeline 110 for one or more events, according to an embodiment of the disclosure. As illustrated, a plurality of sensor assemblies 106A, 106B, 106N−1, 106N may be positioned about the circumference of a pipeline 110. Each of the plurality of sensor assemblies 106A, 106B, 106N−1, 106N may include a number of components, such as an optical receiver, optical transmitter, an optical signal generator, and communications circuitry. In an embodiment, the optical receiver and optical transmitter may be or may be included in a transceiver. In other words, the transceiver may include both of the optical receiver and optical transmitter. Each of the plurality of sensor assemblies 106A, 106B, 106N−1, 106N may additionally include a power source, a fiber optic housing, and/or a fastener and/or adhesive. The power source may include one or more of an energy storage device (such as a battery and/or capacitor based energy storage device) and/or a solar panel. In another embodiment, rather than or in addition to the power source, one or more of each of the plurality of sensor assemblies 106A, 106B, 106N−1, 106N may connect to an external power source, such as an external power source positioned near a pump station and/or destination. Each of the plurality of sensor assemblies 106A, 106B, 106N−1, 106N may include, may be associated with, and/or may connect to a fiber optic cable 108A, 108B, 108N-1, and up to 108N.

In another embodiment, each of the plurality of sensor assemblies 106A, 106B, 106N−1, 106N may be positioned about circumference the pipeline 110 at a selected distance from each adjacent sensor assembly. For example, one sensor assembly may be positioned about 1 mile, 2 mile, 5 mile, 10 mile, 20 mile, 25, mile, 100 miles, or even longer from adjacent sensor assemblies. In another embodiment, each sensor assembly may be positioned closer to each adjacent sensor assembly. When selected events occur, those selected events may create a pressure wave that travels at about 2000 feet per second to about 5000 feet per second, the pressure wave travelling for miles within the pipeline 110. As such, each of the plurality of sensor assemblies 106A, 106B, 106N−1, 106N may be positioned at varying lengths from one another, as described above.

In embodiments, each of the plurality of sensor assemblies 106A, 106B, 106N−1, 106N may include a fiber optic housing. The fiber optic housing may substantially house, contain, and/or encompass the components described herein, for example, the optical receiver, optical transmitter, optical signal generator, communications circuitry, a power source, each end of the fiber optic cable, or some combination thereof. The fiber optic housing may be configured to attach to or connect to a surface of the pipeline 110, for example, via an adhesive applied to a surface of the fiber optic housing or via a connector or mechanical fastener corresponding to connection points on the surface of the pipeline 110.

Each of the plurality of sensor assemblies 106A, 106B, 106N−1, 106N may connect to a controller 104 and/or each adjacent sensor assembly. Such a connection 111 may include a wireless connection, such as via Wi-Fi, a cellular network, and/or satellite. Once the plurality of sensor assemblies 106A, 106B, 106N−1, 106N are positioned about the circumference of the pipeline 110 and connected to the controller 104, the controller 104, in conjunction with the each of the plurality of sensor assemblies 106A, 106B, 106N−1, 106N, may begin determining whether a leak or rupture has occurred, in addition to whether other events or pipeline events have occurred and/or determining various characteristics of the pipeline 110 and/or the fluid therein. To begin determining whether a leak or rupture has occurred (as well as determining if other events have occurred and/or determining characteristics of the pipeline and/or fluid therein), the controller 104 may prompt each of the plurality of sensor assemblies 106A, 106B, 106N−1, 106N to simultaneously, substantially simultaneously, or in a synchronous manner generate an optical signal at selected times or intervals. Upon receiving a prompt, each of the plurality of the sensor assemblies 106A, 106B, 106N−1, 106N may generate an optical signal. Each optical signal may travel through each corresponding fiber optic cable 108A, 108B, 108N-1, 108N from a first end or optical signal transmitting end to a second end or the optical signal receiving end. Each of the plurality of sensor assemblies 106A, 106B, 106N−1, 106N may determine the time-of-flight or transmission time of the corresponding optical signal via a transmission time circuitry. In other words, the transmission time circuitry may determine the transmission time of an optical signal for a sensor assembly. The transmission time circuitry may utilize the following formula to determine time-of-flight or transmission time: t=d/v, where t is the time-of-flight or transmission time, d is the distance traveled by the optical signal, and v is the speed or velocity of the optical signal in the fiber optical cable. The speed or velocity of the optical signal is the speed of light in a vacuum (3×10⁸ m/s) over the refractive index of the fiber optic cable. Each of the plurality of the sensor assemblies 106A, 106B, 106N−1, 106N may then generate a packet including the time-of-flight or transmission time, the time the optical signal was initiated, the time the optical signal was received, a time stamp, a time stamp corresponding to optical signal generation, and a location. Each of the plurality of the sensor assemblies 106A, 106B, 106N−1, 106N may then transmit the packet to the controller 104. To determine whether an event has occurred, the controller 104 may consider a plurality packets from each of the plurality of sensor assemblies 106A, 106B, 106N−1, 106N. Each of the transmission times for each of the plurality of sensor assemblies 106A, 106B, 106N−1, 106N may be compared and, if such a comparison shows a difference in transmission times for a particular sensor assembly, then the controller 104 may determine whether other sensor assemblies exhibited such a difference (or a similar difference) at prior, current, and/or subsequent times or intervals. Based on the determined differences, the controller 104 may determine the type of event.

The controller 104, based on data from each of the plurality of sensor assemblies 106A, 106B, 106N−1, 106N, may determine if different events other than or in addition to leaks or ruptures have occurred and/or determine various characteristics of the pipeline 110 and/or fluid therein. Further, the controller 104 may utilize historical data to determine whether an event has occurred and what the type of event is. For example, the controller 104 may determine and/or track the location and/or status of a pig in the pipeline, determine the wave speed of fluid within the pipeline 110, determine wall thickness 113 of various locations of the pipeline 110 (over time and/or upon initialization of the system), determine whether a blockage exists within the pipeline at a particular location, whether water hold-up exists within the pipeline at a particular section, batch interface tracking, determine ground temperature, and/or determine characteristics of the fluid within the pipeline. In embodiments, each of the plurality of sensor assemblies 106A, 106B, 106N−1, 106N may be positioned closer or further to corresponding sensor assemblies than described above based on the type of event detection and/or characteristic determination desired.

In another example, the controller 104 may utilize historical data trends to determine whether an event has occurred and what the vent is. In such examples, a historical data trend for a sensor assembly may indicate no event has occurred. When selected events or environmental changes occur, data may deviate from the historical data trend. Further, each deviation may be classified based on the actually occurring event and/or environmental change and additional historical data trends, indicative of corresponding events or environmental changes, may be determined. Thus, when a time-of-flight or transmission time for a sensor assembly occurs, the sensor assembly and/or controller can utilize the different historical data trends to quickly determine whether an event has occurred.

As shown in FIG. 1C, the fiber optic cable 108A may include two ends, for example, a first end and a second end. The first end of a fiber optic cable 108A may connect to an input or an output of the sensor assembly 106A at one of connection points 132 and 134. The second end of the fiber optic cable 108A may connect to the output or the input of the sensor assembly 106A at one of connection points 134 and 132. Stated another way, if the first end of the fiber optic cable 108A connects to the input of the sensor assembly 106A at connection point 132, then the second end of the fiber optic cable 108A may connect to the output of the sensor assembly 106A at connection point 134.

In another embodiment, and as illustrated in FIG. 1D, the fiber optic cable 140, 144 may be wrapped or positioned around the pipeline 110 a plurality of times. Each fiber optic cable may include a different number of loops than adjacent fiber optic cables. For example, fiber optic cable 140 may be wrapped or positioned around pipeline 110 seven times (it is noted, however, that such an example is non-limiting and that the fiber optic cable may be wrapped around the pipeline more or less than seven times). In such an embodiment, sensor assembly may include one or more components that are positioned apart. For example, the optical signal generator and output may be included in one of the sub-assemblies (for example, sub-assembly 136 or 138), while the input and the transmission time circuitry may be included in another sub-assembly (for example, sub-assembly 138 or 136). Thus, for example, sub-assembly 136 may generate an optical signal, which may travel through the fiber optic cable 140. Sub-assembly 138 may receive the optical signal and determine the time-of-flight or transmission time of the optical signal. In such embodiments, the time-of-flight or transmission time may detect expansions and contractions of the pipeline 110. The number of loops, in some embodiments, may increase the sensitivity of such detections.

In other embodiments, the fiber optic cable may be wrapped tightly or loosely around the pipeline 110. In other embodiments, the fiber optic cable may be fixed to the pipeline 110 at one or more portions of the pipeline 110. The fiber optic cable may be fixed or positioned against the pipeline 110 via one or more of an adhesive or a mechanical fastener (the mechanical fasteners including brackets and/or other fasteners).

FIG. 1E and FIG. 1F are schematic diagrams of a fiber optic cable and the path a signal may travel therethrough based on a bend or change in the fiber, according to an embodiment of the disclosure. In an embodiment, an optical signal 146 may be input, via an optical signal generator, into a fiber optic cable 148. If the fiber optic cable 148 does not change position, then the time-of-flight or transmission may remain the same. Slight bends or movement of the fiber optic cable 148 may cause the optical signal 146 to reflect off the inner walls of the fiber optic cable 148 differently, causing a change in time-of-flight or transmission time. For example, in FIG. 1F, the fiber optic cable 152 is illustrated as including a slight bend. Thus, the optical signal 150 may exhibit or follow a different path within the fiber optical cable 152, thereby increasing or decreasing the time-of-flight or transmission time of the optical signal 150.

FIG. 1G is a simplified diagram illustrating a sensor assembly 106A, according to an embodiment of the disclosure. As noted, the sensor assembly 106A may include various components. As illustrated, the sensor assembly 106A may include an optical signal generator 116, a transmission time circuitry 122, an optical signal transmitter 118, an optical signal receiver 120, an internal power source 124, and/or a communications circuitry 114. In an embodiment, the sensor assembly 106A may include a memory 130 and a processor 128.

As described herein, the sensor assembly 106A may connect to a controller 104 via a communications circuitry 114. The controller 104 may transmit a prompt to generate an optical signal to the sensor assembly 106A. The sensor assembly 106A may begin generating the optical signal in response to such a signal from the controller 104. In an embodiment, as noted, the sensor assembly 106A may include a processor 128 and a memory 130. In such embodiments, the processor 128 may include a low power processor configured to execute instructions stored in memory 130 to cause the processor 128 to initiate generation of the optical signal and generate a packet including, at least, optical signal time-of-flight or transmission time.

In response to initiation of generation of the optical signal, the optical signal generator 116 may generate an optical signal. The optical signal may be transmitted to the optical signal transmitter 118. In another embodiment, the optical signal transmitter 118 may generate the optical signal. In either embodiment, the optical signal transmitter 118 may transmit the optical signal to the fiber optical cable 108A. The optical signal may be transmitted through the fiber optic cable 108A to the optical signal receiver 120. In an embodiment, the optical signal transmitter 118 may store the time that the optical signal is transmitted in memory 130 and the optical signal receiver 120 may store the time that the optical signal is received in memory 130. The transmission time circuitry 122 may determine the time-of-flight or the transmission time based on the time that the optical signal is transmitted and the time that the optical signal is received.

In an embodiment, the processor 128 and/or the transmission time circuitry 122 may generate a packet or data packet. The data packet may include the time-of-flight, the time the optical signal is generated, the time the optical signal is received, the time the prompt to generate the optical signal is received, and/or the location of the sensor assembly 106A. In such embodiments, the sensor assembly 106A may include a global positioning system (GPS) circuitry. The GPS may provide or determine the location of the sensor assembly 106A. In another embodiment, the location of the sensor assembly 106A may be known and the packet may include an indicator to identify sensor assembly 106A, such as a milepost. The controller 104, as noted, may determine whether a leak or rupture, in addition to other events and/or characteristics, has occurred.

Additionally, the sensor assembly 106A may include a an internal power source 124. The internal power source 124 may include an energy storage device, such as a battery or capacitor, and/or another type of power supply. Further, the sensor assembly 106A may connect to an external power source 126, such as a solar panels and/or other power sources.

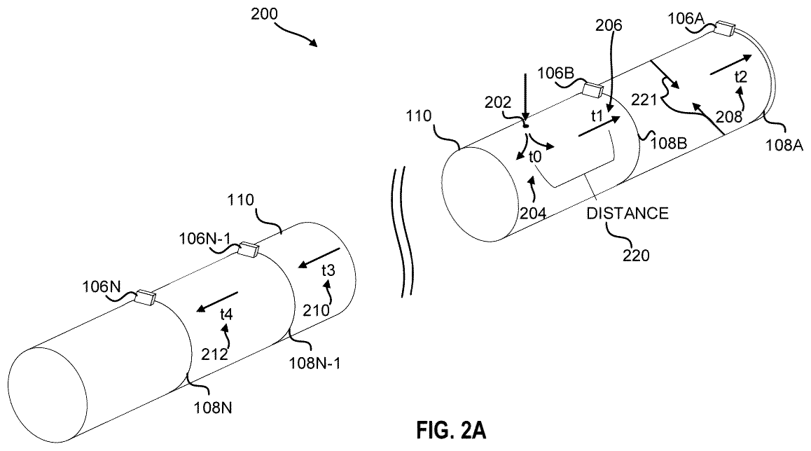

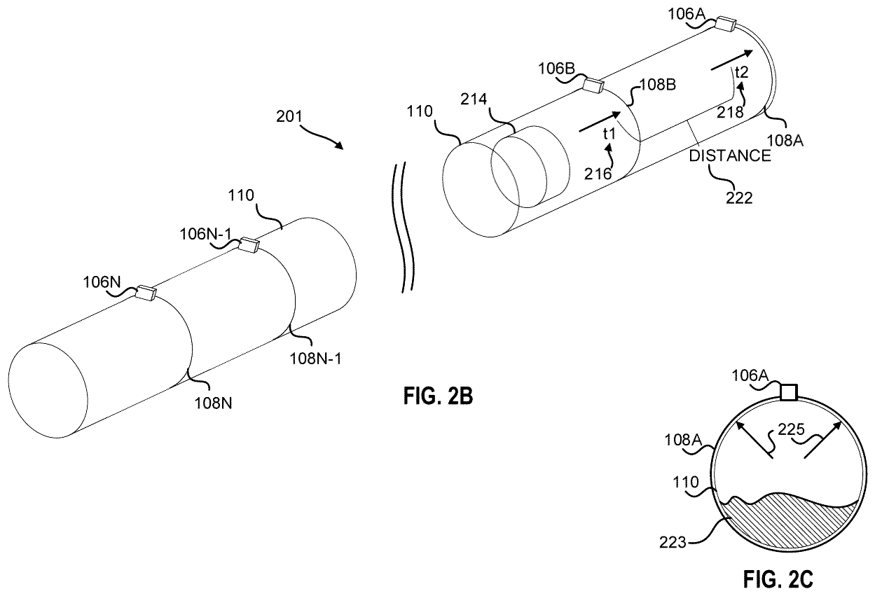

FIG. 2A is a schematic diagram illustrating an example of the plurality of sensor assemblies detecting an event, according to an embodiment of the disclosure. In such an embodiment, the pipeline 110 may experience a leak or rupture (as represented by 202). While this embodiment relates to a leak or rupture, it will be understood that such systems may detect other types of events, as described herein. At a first time, t0 204, the leak or a rupture may have occurred in the pipeline 110. As the leak or rupture occurs, a pressure wave may be generated and may begin to travel through the pipeline 110. At t0, each of the plurality of sensor assemblies 106A, 106B, 106N−1, 106N may generate an optical signal with a time-of-flight or transmission time typical to that sensor assembly. At a second time, t1 206, the pressure wave may reach sensor assembly 106B. As the pressure wave reaches, the pressure wave may cause the pipe to slightly expand and/or then contract. As such at t1 206, the sensor assembly 106B may generate an optical signal with a time-of-flight or transmission time that is longer or slightly longer or, in other embodiments, less or slightly less than typical, due to the slight expansion of the pipeline 110. The following contraction may then cause a change in the time-of-flight or transmission time. As the pressure wave continues down the pipeline 110, at a third time, t2 208, the sensor assembly 106A may generate an optical signal with a time-of-flight or transmission time that is longer or slightly longer than typical, due to the slight expansion of the pipeline. Further, at t2, it is noted that a next optical signal generated at sensor assembly 106B may include a time-of-flight or transmission time different than that of the optical signal generated at t1 206. In an embodiment, distance 220 represents the distance such a pressure wave may travel from time t0 204 to time t1 206.

Further, as the pressure wave continues to travel down the pipeline and reaches subsequent sensor assemblies at a fourth time and fifth time, t3 210 and t4 212, respectively, each sensor assembly (such as sensor assemblies 106N−1 and 106N) may generate an optical signal with longer or slightly longer time-of-flights or transmission times. As each of these sensor assemblies gather data, the gathered data may be sent to the controller (such as controller 104). The controller 104 may determine that a pressure change has occurred (for example, based on expansion or contraction of the pipeline 110) and, thus, that a leak or rupture has occurred based on the different time-of-flights or transmission times.

Further, the controller may determine the location of the leak or rupture. For example, using the following equation,

$$( x 1 + M ) - ( ( \frac{A}{2} ) * T ) .$$

In such examples, T represents the absolute value between two or more times, such as t1 206 and t2 208. A represents the wave speed of the fluid within the pipeline 110. X1 represents the milepost or location of the sensor assembly 106B that recognizes the pressure change at t1 206. Finally, M represents x2−x1/x2, where x2 represents the milepost or location of the sensor assembly 106A that recognizes the pressure change (or, in other embodiments, an expansion or contraction of the pipeline 110) at t2 208. Thus, the controller may accurately determine that a leak or rupture has occurred and where the leak or rupture has occurred.

FIG. 2B is another schematic diagram illustrating an example of the plurality of sensor assemblies detecting an event, according to an embodiment of the disclosure. In such an embodiment, a pig 214 may be passing through the pipeline 110. As the pig 214 passes through the pipeline 110, the pig 214 may generate a pressure differential (for example, based on the location of the actual pig 214 and/or based on the fluid propelling the pig 214). At t1 216, each of the plurality of sensor assemblies 106A, 106B, 106N−1, 106N may generate an optical signal that results in a measurement of a pressure indicative of a pig 214 nearby sensor assembly 106B. At t2 218, a subsequent measurement may indicate passage of the pig 214 further down the pipeline 110. Subsequent measurements at each of the plurality of sensor assemblies 106A, 106B, 106N−1, 106N may indicate whether or may be utilized to determine the position of the pig 214 at some location within the pipeline. Thus, a controller, using such measurements over time, may determine the location of the pig 214 at any given time. In an embodiment, distance 222 represents the distance a pressure wave or change in fluid may travel from time t1 216 to time t2 218.

As noted, other events may occur and/or other parameters measured via such systems. For example, the controller may determine the wave speed of fluid within the pipeline, determine wall thickness of various locations of the pipeline (over time and/or upon initialization of the system), determine whether a blockage exists within the pipeline at a particular location, whether a water hold-up exists within the pipeline at a particular section, batch interface tracking, determine ground temperature, and/or determine characteristics of the fluid within the pipeline.

FIG. 2C is a schematic diagram illustrating an example of the plurality of sensor assemblies detecting an event, according to an embodiment of the disclosure. In an embodiment, an event may include a blockage 223. In an embodiment, blockages may occur at a selected time or over a period of time within pipelines. When a blockage occurs, the pressure within the pipeline 110 may increase. Such an increase in pressure may cause the pipe to expand (see 225 in FIG. 2C). Such an expansion may be slight in comparison to typical expansion. Further, the amount that the pipeline 110 expands may remain after the time that the blockage 223 occurs. Thus, the sensor assembly 106A may detect a change in the time-of-flight or transmission time of light within the fiber loop 108A. Further, the sensor assembly 106A and/or a controller may differentiate the detected change from typical changes (for example, du to temperature and/or other naturally occurring changes) based on the amount of the change and/or based on the amount of time that the change remains.

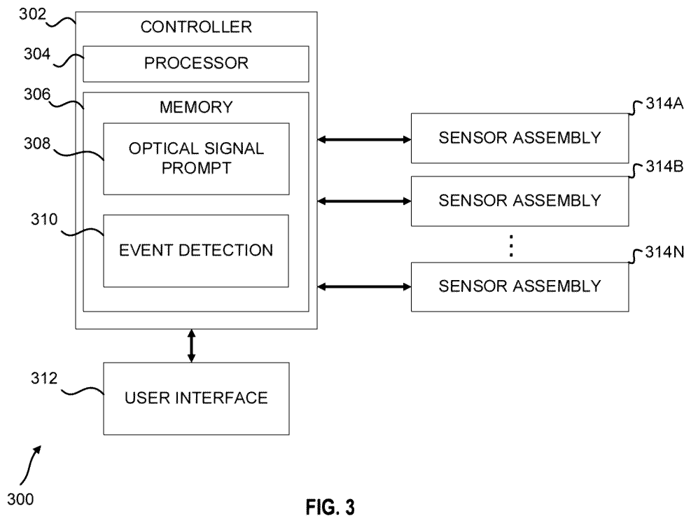

FIG. 3 is another simplified diagram illustrating a control system 300 for utilizing each of the sensor assemblies to detect a pipeline event, according to an embodiment of the disclosure. In an example, the control system 300 may include a controller 302 or one or more controllers. Further the controller 302 may be in signal communication with various other controllers throughout or external to a refinery or terminal. The controller 302 may be considered a supervisory controller. In another example, a supervisory controller may include the functionality of controller 302 and may control or manage other proximate and/or remote controllers. In another embodiment, rather than a controller 302, a computing device may be utilized.

Each controller described above and herein may include a machine-readable storage medium (for example, memory 306) and one or more processors (for example, processor 304). As used herein, a “machine-readable storage medium” may be any electronic, magnetic, optical, or other physical storage apparatus to contain or store information such as executable instructions, data, and the like. For example, any machine-readable storage medium described herein may be any of random access memory (RAM), volatile memory, non-volatile memory, flash memory, a storage drive (e.g., hard drive), a solid state drive, any type of storage disc, and the like, or a combination thereof. The memory 306 may store or include instructions executable by the processor 304. As used herein, a “processor” may include, for example one processor or multiple processors included in a single device or distributed across multiple computing devices. The processor 304 may be at least one of a central processing unit (CPU), a semiconductor-based microprocessor, a graphics processing unit (GPU), a field-programmable gate array (FPGA) to retrieve and execute instructions, a real time processor (RTP), other electronic circuitry suitable for the retrieval and execution instructions stored on a machine-readable storage medium, or a combination thereof.

As used herein, “signal communication” refers to electric communication such as hard wiring two components together or wireless communication, as understood by those skilled in the art. For example, wireless communication may be Wi-Fi®, Bluetooth®, ZigBee, or forms of near field communications. In addition, signal communication may include one or more intermediate controllers or relays disposed between elements that are in signal communication with one another.

As noted, the controller 302 may include instructions stored in memory 306 and executable by the processor 304. The memory may include instructions 308 to cause one or more sensor assemblies 314A, 314B, and up to 314N to generate an optical signal, the optical signal to indicate a pressure change or other change within a pipeline. Instructions 308 may be executed at a selected interval. In another embodiment, the instructions 308 may be executed such that the one or more sensor assemblies 314A, 314B, and up to 314N store the prompt and generate optical signals at a regular interval. While the interval may be seconds or minutes, an interval of about 1 second may be utilized due to potential pressure waves caused by leaks or ruptures traveling at high speeds, such as thousands of feet per minute. Further, the prompt to generate the optical signal may be synchronous. In other words, all sensor assemblies 314A, 314B, and up to 314N may generate optical signals at the same or substantially the same time.

The controller 302 may include instructions 310 to detect an event. Subsequent to the generation of optical signals, each of the sensor assemblies 314A, 314B, and up to 314N may determine the transmission time of each optical signal. The sensor assemblies 314A, 314B, and up to 314N may send the transmission times to the controller 302. The controller 302 may determine whether an event has occurred based on each transmission time, as well as previously determined transmission times (as well as other data, in other embodiments). For example, the controller 302 may utilize historical transmission time data and current transmission time data to determine whether a pressure change has occurred. Further, the controller 302 may determine that the transmission time indicates a pressure change, rather than typical or gradual wear over time. Further, the controller 302 may utilize the transmission times to determine if gradual wear indicates potential issues, thus requiring repair. Further, the controller 302 may distinguish between pressure changes and temperature changes (which may, in embodiments, cause expansion or contraction of the pipeline) based on historical data, as pipeline circumference may change as environmental temperatures and/or temperatures of the fluid in the pipeline change. Finally, since the sensor assemblies 314A, 314B, and up to 314N are positioned along the pipeline, the controller 302 may determine if a change in a transmission time is an anomaly, rather than a pressure change.

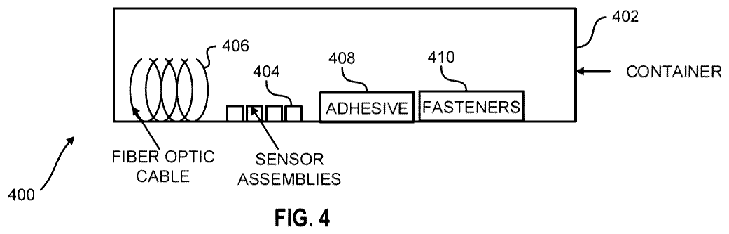

FIG. 4 is a schematic diagram of a kit containing the sensor assemblies, fiber optic cable, adhesive, and/or fasteners, according to an embodiment of the disclosure. In an embodiment, the kit 400 may include a container 402. Various components may be positioned within the container 402 to enable installation of a plurality of sensor assemblies 404, such as fiber optic cable 406, the sensor assemblies 404, adhesive 408, fasteners 410, instructions, and/or schematic diagrams. The fiber optic cable 406 may be provided within the container as individual, pre-measured strands or as a spool. Further, the instructions and/or schematic diagrams may indicate where and how to install each of the sensor assemblies 404 and fiber optic cable 406. The instructions and/or schematic diagrams may indicate to a user to position the fiber optic cable 406 in one or more loops about the circumference of the pipeline at a particular milepost. The instructions and/or schematic diagrams may indicate to the user to connect one end of the fiber optic cable 406 to the sensor assembly and another end of the fiber optic cable 406 to the other end of the sensor assembly. The instructions and/or schematic diagrams may then indicate for the user to attach the sensor assembly to the pipeline, for example, via the adhesive 408 and/or fastener 410. Further, the instructions and/or schematic diagrams may indicate for the user to secure the fiber optic cable to the pipeline as well, via the adhesive 408 or fastener 410.

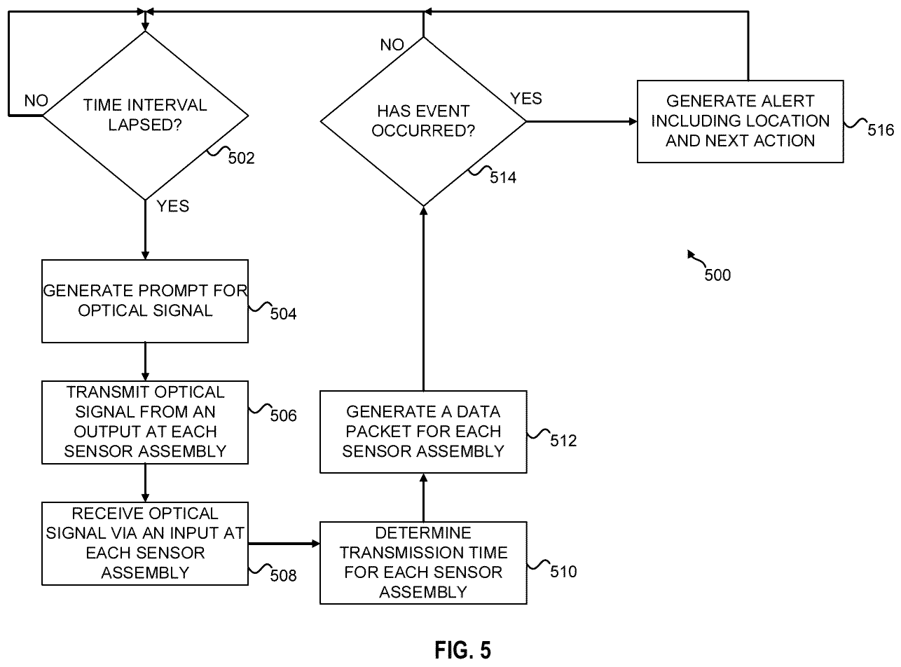

FIG. 5 is a flow diagram for monitoring a pipeline for a leak or rupture, according to an embodiment of the disclosure. The method 500 is detailed with reference to the controller 302 of FIG. 3. Unless otherwise specified, the actions of method 500 may be completed within the controller 302. Specifically, method 500 may be included in one or more programs, protocols, or instructions loaded into the memory of the controller 302 and executed on the processor or one or more processors of the controller 302. The order in which the operations are described is not intended to be construed as a limitation, and any number of the described blocks may be combined in any order and/or in parallel to implement the methods.

At block 502, the controller 302 may determine whether a time interval has lapsed. Such a time interval may include a second, 30 seconds, 1 minute, and/or even longer. The time interval may indicate when optical signals are to be generated via one or more sensor assemblies. When optical signal generation occurs, the controller 302 may utilize the subsequently generated data to determine whether a pressure change and/or other change has occurred and, thus, whether a leak, rupture, or other event has occurred. If the time interval has not lapsed, the controller 302 may wait.

At block 504, if the time interval has lapsed, the controller 302 may prompt each of the one or more sensor assemblies to generate an optical signal. The controller 302 may transmit such a prompt to each of the one or more sensor assemblies at the same time to ensure that the optical signals are generated synchronously. In other embodiments, the controller 302 may transmit the prompt to one or more of the sensor assemblies at asynchronous times for a number of reasons. For example, the controller 302 may prompt a single sensor assembly to generate an optical signal to determine whether the sensor assembly is malfunctioning or experiencing some issue.

At block 506, the sensor assemblies that receive the prompt may generate an optical signal and transmit that optical signal at an optical output or optical signal transmitter associated with a corresponding sensor assembly. At block 508, the optical signal be transmitted through the fiber optic cable to an input or optical signal receiver. In other words, the input or optical signal receiver may receive the generated optical signal from a corresponding sensor assembly.

At block 510, each of the sensor assemblies may determine the time-of-flight or transmission time for each corresponding optical signal. In other words, the sensor assembly may determine the time from transmission to reception of the optical signal. At block 512, after determining the time-of-flight or transmission time, each sensor assembly may generate a data packet. The data packet may include the time-of-flight or transmission time. In another embodiment, the data packet may also include the transmission time, the reception time, a time stamp, and/or location data and/or a milepost indicator. In an embodiment, rather than the sensor assembly determining and including the time-of-flight or transmission time, the sensor assembly may include other data in the data packet and the controller 302, based on that data, may determine the time-of-flight or transmission time.

At block 514, the controller 302 may determine if an event has occurred based on each transmission time data packet and previous transmission time data. For example, if the transmission time data for a particular sensor assembly has changed (for example, increased and/or decreased), then an event may have occurred. The controller 302 may utilize additional or subsequent transmission times to determine whether an event has actually occurred, rather than an anomaly. If no event has occurred, then the controller 302 may continue to generate prompts for optical signals at a selected time intervals. In another embodiment, an event may also include a lack of reception of a transmission time or data packet from a sensor assembly, the lack of reception indicating a potential sensor assembly failure.

At block 516, if the controller 302 has determined that an event has occurred, then the controller 302 may generate an alert. The alert, in an embodiment, may include the type of event, the severity level of the event, and/or any remedial and/or next actions to resolve the event.

This application claims priority to and the benefit of U.S. Provisional Application No. 63/541,159, filed Sep. 28, 2023, titled “METHODS AND SYSTEMS FOR MONITORING PIPELINE WITH FIBER OPTIC CABLE,” the disclosure of which is incorporated herein by reference in its entirety.

In the drawings and specification, several embodiments of systems and methods to provide in-line mixing of hydrocarbon liquids have been disclosed, and although specific terms are employed, the terms are used in a descriptive sense only and not for purposes of limitation. Embodiments of systems and methods have been described in considerable detail with specific reference to the illustrated embodiments. However, it will be apparent that various modifications and changes may be made within the spirit and scope of the embodiments of systems and methods as described in the foregoing specification, and such modifications and changes are to be considered equivalents and part of this disclosure.

What is claimed is:

1. A system to monitor a pipeline for a leak or a rupture via transmission time of optical signals through a plurality of fiber optic cables, the system comprising:
a plurality of sensor assemblies each including:
a transceiver including:
an optical signal generator to generate an optical signal, in response to a prompt,
an input,
an output, and
a transmission time circuitry configured to:
determine a transmission time to indicate a change in circumference of the pipeline at a location of one of the plurality of sensor assemblies of the optical signal based on a period of time between transmission via the output and reception via the input of the optical signal and based on an expansion or contraction of the pipeline, and
generate a transmission time data packet including the transmission time, a timestamp, and the location of the transceiver;
a fiber optic cable positionable about a circumference of the pipeline and including:
a first end connected to the output of the transceiver and to receive the optical signal from the optical signal generator, and
a second end connected to the input of the transceiver and to receive the optical signal via the first end and provide the optical signal to the input;
communications circuitry configured to transmit the transmission time data packet; and
a controller connected to the communications circuitry of each of the plurality of sensor assemblies, the controller configured to:
prompt each of the plurality of sensor assemblies to generate the optical signal,
receive the transmission time data packet from each the plurality of sensor assemblies, and
determine whether one of the leak or the rupture has occurred based on the transmission time data packet from each of the plurality of sensor assemblies.

2. The system of claim 1, wherein determination of occurrence of one of the leak or the rupture is indicated based on a difference between (a) a first transmission time data packet from a first sensor assembly including a first timestamp and a different transmission time than previously received one or more transmission times and (b) a second transmission time data packet from a second sensor assembly including a second timestamp and another different transmission time than previously received one or more transmission times, the second timestamp comprising a time subsequent to the first timestamp.

3. The system of claim 2, wherein the difference between the first transmission time data packet and the second transmission time data packet is based on one or more of (a) a number of times a fiber optic cable loops around the circumference of the pipeline, (b) material properties of the pipeline, (c) a wall thickness of the pipeline, or (d) a magnitude of pressure change that results from one of the leak or the rupture.

4. The system of claim 1, wherein each of the plurality of sensor assemblies is within a distance of about 1 mile, about 5 miles, about 10 miles, about 25 miles, about 50 miles, or about 100 miles from adjacent sensor assemblies.

5. The system of claim 1, wherein the controller is further configured to determine a location of the one of the leak or rupture based on a plurality of transmission time data packets received from two or more of the plurality of sensor assemblies over a selected time period.

6. The system of claim 5, wherein the controller is further configured to generate an alert in response to a determination that one of a leak or rupture has occurred, the alert comprising the location of the one of the leak or rupture and a time that the leak or rupture has occurred.

7. The system of claim 1, wherein the controller is further configured to generate an alert in response to a lack of reception of transmission time data packets from any one of the plurality of sensor assemblies, the alert to indicate sensor assembly location and sensor assembly maintenance.

8. The system of claim 1, wherein the controller is further configured to determine a transmission time profile for each one of the plurality of sensor assemblies based on a plurality of transmission time data packets for each corresponding one of the plurality of sensor assemblies.

9. The system of claim 1, wherein the controller is further configured to determine whether the one of the leak or rupture occurred based on transmission time profiles and currently received transmission time data packets.

10. The system of claim 1, wherein the controller is further configured to determine whether an event has occurred, and wherein the event comprises one or more of (a) a blockage (b) a passage of a pig through the pipeline, or (c) a water hold-up.

11. The system of claim 1, wherein the controller is further configured to determine one or more of (a) a wave speed of material in the pipeline or (b) pig location and status.

12. The system of claim 1, wherein transmission of the prompt to generate the optical signal to each of the plurality of sensor assemblies occurs at a selected time interval and one of (a) synchronously, (b) substantially synchronously, or (c) asynchronously, and wherein the selected time interval comprises about 1 second, about 1 minute, about 30 minutes, or about 1 hour.

13. A fiber optic sensor assembly to monitor a pipeline for a plurality of events, the fiber optic sensor assembly comprising:
an optical signal generator to generate an optical signal in response to a prompt;
an optical signal receiver;
an optical signal transmitter;
a transmission time circuitry configured to:
determine a transmission time of the optical signal, based on a period of time between transmission via the optical signal transmitter and reception via the optical signal receiver of the optical signal, to indicate (a) a change in circumference of the pipeline at a location of the fiber optic sensor assembly based on previous transmission times and (b) occurrence of one of the plurality of events based on previous transmission times and transmission times from adjacent fiber optic sensor assemblies, and
generate a transmission time data packet including the transmission time, a timestamp, and the location of the fiber optic sensor assembly;
a fiber optic cable positionable about a circumference of the pipeline and including:
a first end connected to the optical signal transmitter and to receive the optical signal from the optical signal generator, and
a second end connected to the optical signal receiver and to receive the optical signal via the first end and provide the optical signal to the optical signal receiver; and
a communications circuitry configured to transmit the transmission time data packet.

14. The fiber optic sensor assembly of claim 13, wherein the communications circuitry is configured to connect to one or more of a controller or the adjacent fiber optic sensor assemblies.

15. The fiber optic sensor assembly of claim 13, further comprising a fiber optic housing, and wherein the optical signal generator, the optical signal receiver, the optical signal transmitter, the transmission time circuitry, and the communications circuitry are positioned substantially within the fiber optic housing.

16. The fiber optic sensor assembly of claim 15, wherein a lower surface of the fiber optic housing includes a connector, and wherein the connector includes one or more of a mechanical fastener or adhesive to attach the fiber optic housing to the pipeline.

17. A kit to provide a plurality of sensor assemblies to monitor a pipeline for selected events, the kit comprising:
a container;
a plurality of sensor assemblies positioned within the container and each including:
an optical signal generator to, in response to a prompt, generate an optical signal,
an optical signal receiver,
an optical signal transmitter,
a transmission time circuitry configured to:
determine a transmission time of the optical signal, based on a period of time between transmission via the optical signal transmitter and reception via the optical signal receiver of the optical signal, to indicate (a) a change in circumference of the pipeline at a location of one of the plurality of sensor assemblies based on previous transmission times and (b) occurrence of one of the selected events based on previous transmission times and transmission times from adjacent sensor assemblies, and
generate a transmission time data packet including the transmission time, a timestamp, and the location of the one of the plurality of sensor assemblies, a fiber optic cable positionable about a circumference of the pipeline and including:
a first end configured to connect to the optical signal transmitter and to receive the optical signal from the optical signal generator, and
a second end configured to connect to the optical signal receiver and to receive the optical signal via the first end and provide the optical signal to the optical signal receiver,
a communications circuitry configured to transmit the transmission time data packet, and
a fiber optic housing to substantially contain the optical signal generator, the optical signal receiver, the optical signal transmitter, the transmission time circuitry, and the communications circuitry within; and
a plurality of connectors to connect each fiber optic housing and fiber optic cable about the circumference of the pipeline.

18. The kit of claim 17, further comprising, for each of the plurality of sensor assemblies, a power source configured to connect to the optical signal generator and the communications circuitry, and wherein the power source is positioned substantially within the fiber optic housing.

19. The kit of claim 17, further comprising, for each of the plurality of sensor assemblies, at least two redundant power sources each configured to connect to the optical signal generator and the communications circuitry, wherein the redundant power sources are positioned substantially within the fiber optic housing, and wherein each of the redundant power sources are hot-swappable.

20. A method to monitor a pipeline for selected events, the method comprising
generating a prompt to indicate generation of an optical signal at each of a plurality of sensor assemblies and determination of a transmission time that corresponds to transmission of the optical signal through a fiber optic cable associated with one of the plurality of sensor assemblies, the fiber optic cable positioned about a circumference of the pipeline,
transmitting the optical signal at each of the plurality of sensor assemblies from an optical transmitter associated with one of the plurality of sensor assemblies,
receiving the optical signal at optical input associated with the one of the plurality of sensor assemblies;
determining a transmission time of the optical signal;
generating a transmission time data packet to include, the transmission time, location of the one of the plurality of sensor assemblies, and a timestamp to indicate when the optical signal was generated; and
determining if one of the selected events has occurred at a location of the pipeline based on transmission time data packets from the plurality of sensor assemblies and previously generated transmission time data packets from the plurality of sensor assemblies.

21. The method of claim 20, wherein the selected events include one or more of a leak or rupture.

22. A method to monitor a pipeline for selected events, the method comprising
transmitting an optical signal at one or more of a plurality of sensor assemblies from an optical transmitter associated with one of the plurality of sensor assemblies,
receiving the optical signal at optical input associated with the one of the plurality of sensor assemblies;
determining a transmission time of the optical signal;
generating a transmission time data packet to include, the transmission time, location of the one of the plurality of sensor assemblies, and a timestamp to indicate when the optical signal was generated; and
determining if one of the selected events has occurred at a location of the pipeline based on transmission time data packets from the plurality of sensor assemblies and previously generated transmission time data packets from the plurality of sensor assemblies.

23. The method of claim 22, further comprising:
determining one or more characteristics of the pipeline based on transmission time data packets from the plurality of sensor assemblies and previously generated transmission time data packets from the plurality of sensor assemblies.

24. The method of claim 22, further comprising:
correlating the transmission time of the optical signal to a differential pressure, and wherein determination if the one of the selected events has occurred is based on the differential pressure.
